(19) United States
(12) Patent Application Publication
(10) Pub. No.: US 2026/0262617 A1
(43) Pub. Date: Sep. 10, 2026

(54) UNDERWATER DEVICE AND SYSTEM EQUIPPED WITH A PAIR OF UNDERWATER DEVICES FOR STEERING AN UNDERWATER FISHING TRAWL

(71) Applicant: TECHNOLOGIES DE PECHE AQUARIUS INC., Sherbrooke (CA)

(72) Inventors: Gabriel AUDET, Beaupré (CA); Guillaume BEAUDIN, Candiac (CA); Chloe DUCHESNE, Bathurst (CA); Emile GAGNE, Bolton-Ouest (CA); Xavier LEMELIN, Lac-Beauport (CA); Christophe ROY, Sherbrooke (CA); Jeremie THERRIEN, Gatineau (CA); Heidi TREMBLAY, Gatineau (CA)

(73) Assignee: TECHNOLOGIES DE PECHE AQUARIUS INC., Sherbrooke (CA)

(21) Appl. No.: 19/071,873

(22) Filed: Mar. 6, 2025

(51) Int. Cl. A01K 73/02; B63B 35/16

(52) U.S. Cl. CPC A01K 73/025; B63B 35/16

(57) ABSTRACT

System and underwater device for steering an underwater fishing trawl. The system comprises a depth sonar generating an underwater detected signal representative of a vertical distance to a sea floor. The system also comprises a pair of underwater devices. Each underwater device is adapted for being pulled by a fishing boat and for steering one of two extremities of the underwater fishing trawl. Each underwater device comprises a central body, a pair of adjustable hydrofoils, a pair of controllers and a processor. The hydrofoils are positioned on each side of the central body. Each controller is adapted for controlling rotation of one of the hydrofoils with respect to the central body. The processor receives the underwater detected signal and controls the pair of controllers based at least on the underwater detected signal, thereby controlling the pair of adjustable hydrofoils and steering the underwater fishing trawl.

### TECHNICAL FIELD

The present disclosure relates to the field of fisheries, and more particularly to the control of an underwater fishing trawl pulled by a boat.

### BACKGROUND

Commercial fishing activities rely on the use of fishing trawls. The fishing trawls are deployed underwater behind a boat and pulled by the boat. A pair of lines are used to pull the fishing trawl, and the pulling force by the boat is used to pull the fishing trawl underwater.

Thus the direction of the fishing trawl is dependent on the movement of the boat. This particularly limits greatly the control over the underwater fishing trawl movements.

Improving the maneuverability of the underwater fishing trawl could greatly assist fishermen. For example, it could be advantageous to adjust the depth of the underwater fishing trawl based on a depth where the shoals of fishes are located. It could also be advantageous to allow movement of the underwater fishing trawl so as to prevent obstacles and entanglement.

There is therefore a need for an underwater device which alleviates the current problems with underwater fishing trawls, and for a system equipped with a pair of underwater devices for steering an underwater fishing trawl.

### SUMMARY

According to a first aspect, the present disclosure relates to a system for steering an underwater fishing trawl. The system comprises a depth sonar generating an underwater detected signal representative of a vertical distance to a sea floor. The system comprises a pair of underwater devices, each underwater device being adapted for being pulled by a fishing boat and for steering one of two extremities of the underwater fishing trawl. Each underwater device comprises a central body and a pair of adjustable hydrofoils, the hydrofoils being positioned on each side of the central body. Each underwater device further comprises a pair of controllers, each controller being adapted for controlling rotation of one of the hydrofoils with respect to the central body. Each underwater device further comprises a processor for receiving the underwater detected signal and for controlling the pair of controllers based at least on the underwater detected signal, thereby controlling the pair of adjustable hydrofoils and steering the underwater fishing trawl.

According to a particular aspect, the depth sonar is positioned on one of the underwater devices.

According to another particular aspect, the underwater devices further comprise an orientation mechanism for orienting the central body between the fishing boat and the fishing trawl. In a particular embodiment, the orientation mechanism comprises a rotating arm and a fin installed on the central body. In another particular embodiment, one extremity of the rotating arm is pulled by the fishing boat and another extremity of the rotating arm is attached to a fishing equipment comprising the fishing trawl.

According to another particular aspect, the processor of each underwater device is further adapted for receiving from the fishing boat a height target and controlling the pair of controllers to maintain the fishing trawl at the height objective, the height target defining a target height relative to the sea floor.

According to yet another particular aspect, each underwater device further comprises a gyroscope for generating a gyroscopic signal. The processor of each of the underwater devices is further adapted for receiving the gyroscopic signal and controlling the pair of controllers based on the gyroscopic signal for reducing rolling movement of the fishing trawl.

According to another particular aspect, the system further comprises another sonar generating another underwater detected signal representative of a presence of an obstacle or a shoal of fishes. The processor is further adapted for receiving the other underwater detected signal and controlling the pair of controllers based on the other underwater detected signal. In a particular embodiment, the system further comprises at least one camera. The camera generates underwater images and the processor is further adapted for analyzing the underwater images and confirming presence of an obstacle or a shoal of fishes. In another particular embodiment, controlling the pair of controllers based on the other underwater detected signal thereby controls the pair of adjustable hydrofoils to avoid the obstacle or to steer the fishing trawl in the direction of the shoal of fishes.

According to still another particular aspect, the pair of underwater devices are further adapted for closing and opening the underwater fishing trawl while being pulled.

According to yet another particular aspect, the pair of underwater devices communicates with the fishing boat with one of: a cable or an acoustic communication device.

According to another particular aspect, the system further comprises an additional distance sensor adapted for determining a vertical distance to the sea floor.

According to a second aspect, the present disclosure relates to an underwater device adapted for being attached to an underwater fishing trawl system, the underwater fishing trawl system comprising a fishing trawl and a fishing boat. The underwater device comprises a central body and a pair of adjustable hydrofoils, the hydrofoils being positioned on each side of the central body. The underwater device further comprises a pair of controllers, each controller being adapted for controlling rotation of one of the hydrofoils. The underwater device further comprises a processor for receiving a sonar signal representative of a vertical distance to a sea floor and for controlling the pair of controllers based at least on the sonar signal, thereby controlling the pair of adjustable hydrofoils and steering the underwater fishing trawl.

In a particular aspect, the underwater device further comprises a sonar for generating the sonar signal.

In another particular aspect, the underwater device further comprises an orientation mechanism for orienting the central body between the fishing boat and the fishing trawl. In a particular embodiment, the orientation mechanism comprises a rotating arm and a fin installed on the central body. In another particular embodiment, one extremity of the rotating arm is pulled by the fishing boat and another extremity of the rotating arm is attached to a fishing equipment comprising the fishing trawl.

In still another particular aspect, the processor is further adapted for receiving from the fishing boat a height target and controlling the pair of controllers to maintain the fishing trawl at the height target, the height target defining a target height relative to the sea floor.

In yet another particular aspect, the underwater device further comprises a gyroscope for generating a gyroscopic signal. The processor is further adapted for receiving the gyroscopic signal and controlling the pair of controllers based on the gyroscopic signal for reducing rolling movement of at least one of the underwater device and the fishing trawl.

In another particular aspect, the processor is further adapted for receiving another sonar signal representative of a presence of an obstacle or a shoal of fishes, and controlling the pair of controllers based on the other sonar signal. In a particular embodiment, the underwater device further comprises at least one camera, the camera generating underwater images. The processor is further adapted for analyzing the underwater images and confirming presence of an obstacle or of a shoal of fishes. In another particular embodiment, controlling the pair of controllers based on the other sonar signal thereby controls the pair of adjustable hydrofoils to avoid the obstacle or to steer the fishing trawl in the direction of the shoal of fishes.

In still another particular aspect, the underwater device is further adapted for closing and opening the underwater fishing trawl while being pulled.

In yet another particular aspect, the underwater device further comprises a communication unit for communicating with the fishing boat with one of: a cable or an acoustic communication device.

### BRIEF DESCRIPTION OF THE DRAWINGS

Embodiments of the disclosure will be described by way of example only with reference to the accompanying drawings, in which:

FIG. 1 illustrates a legacy fishing equipment;

FIG. 2A illustrates the legacy fishing equipment of FIG. 1 with a pair of underwater devices attached along lower bridles of a fishing trawl in accordance with the present invention;

FIG. 2B illustrates the legacy fishing equipment of FIG. 1 with the pair of underwater devices attached along warps in accordance with another embodiment of the present invention;

FIG. 2C illustrates the legacy fishing equipment of FIG. 1 with the pair of underwater devices in accordance with yet another embodiment of the present invention where the underwater devices are pulled by a boat and attached to lower bridles of the fishing trawl in accordance with another embodiment;

FIG. 2D illustrates the legacy fishing equipment of FIG. 1 with the pair of underwater devices attached along a footrope of the fishing trawl in accordance with still another embodiment of the present invention;

FIG. 3 illustrates a top view of the present underwater device;

FIG. 4A illustrates a schematic representation of components for controlling operation of the underwater device in a first embodiment inside the central body 110;

FIG. 4B illustrates a schematic representation of components of controlling operation of the underwater device in a second embodiment divided between the central body 110 and a boat 10; and

FIGS. 5, 6A and 6B illustrate a method for controlling a fishing trawl being pulled by a boat in accordance with the present invention.

### DETAILED DESCRIPTION

The foregoing and other features will become more apparent upon reading of the following non-restrictive description of illustrative embodiments thereof, given by way of example only with reference to the accompanying drawings. Like numerals represent features on the various drawings.

Various aspects of the present disclosure generally address the steering of an underwater fishing trawl pulled by a fishing boat by means of an underwater device. More specifically, a system is equipped with a pair of underwater devices, each underwater device being attachable to a fishing trawl's line for being pulled by the fishing boat and for steering one of two extremities of the underwater fishing trawl. The pair of underwater devices provide several functionalities for safely and effectively steering the underwater fishing trawl, including obstacle avoidance, height target enforcement, etc.

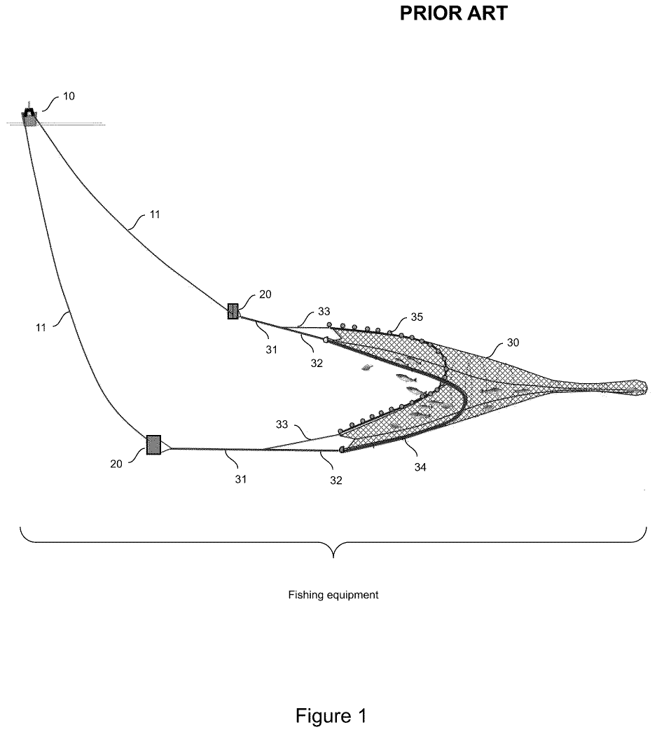

Reference is now made to FIG. 1, where FIG. 1 illustrates a legacy fishing equipment illustrating various components including an underwater fishing trawl 30 according to the prior art.

The underwater fishing trawl 30 represented in FIG. 1 comprises components well known in the art, and is for illustration purposes only. Each extremity of the underwater fishing trawl 30 comprises a sweep 31, the sweep 31 being connected to a lower bridle 32 and an upper bridle 33. The lower bridle 32 at each extremity is connected to a footrope 34. The upper bridle 33 at each extremity is connected to a headrope with floats 35.

The underwater fishing trawl 30 is pulled by a fishing boat 10 via a pair of otter boards 20 (also commonly referred to as doors, pelagic doors or semi-pelagic doors in the fishing industry). More specifically, each otter board 20 is pulled by the fishing boat 10 via a warp 11. Each otter board 20 pulls one extremity of the underwater fishing trawl 30, more specifically one of the sweeps 31. The pair of otter boards 20 are used to control an horizontal opening of the underwater fishing trawl 30.

In the following, a reference to the fishing equipment includes the previously mentioned components (30, 31, 32, 33, 34, 35, 20 and 11), except the fishing boat 10.

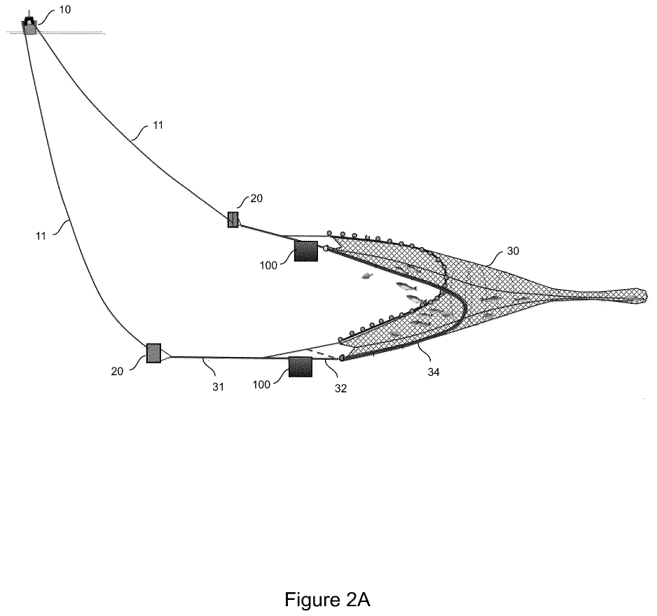

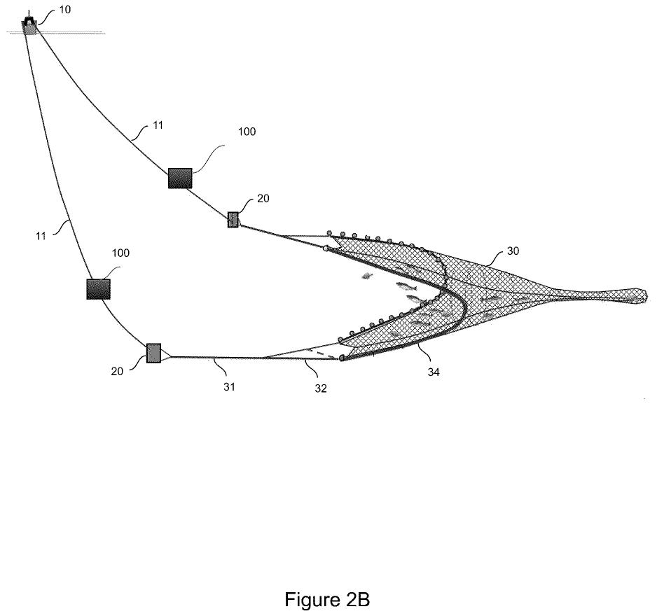

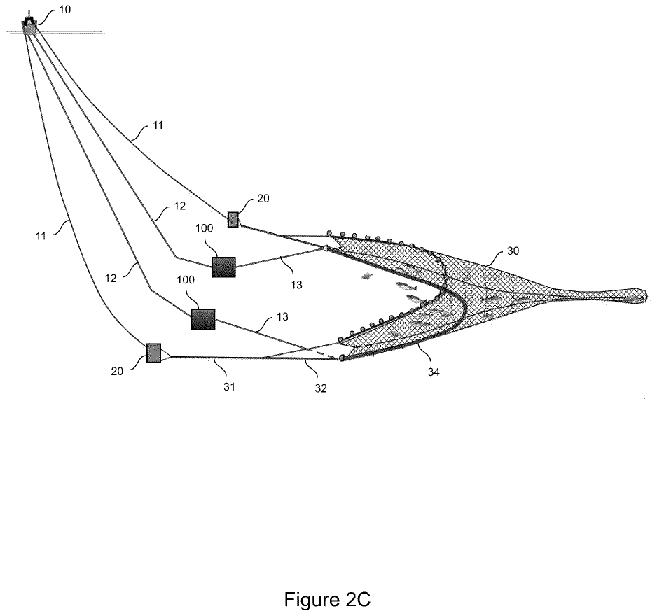

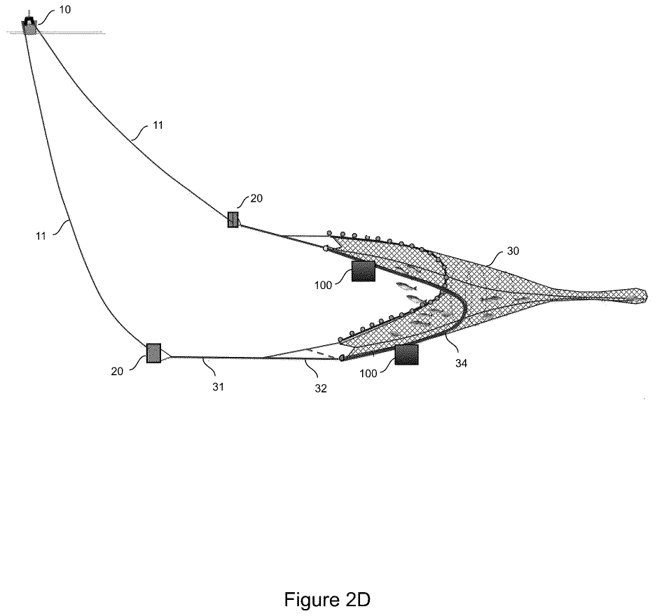

Reference is now made concurrently to FIGS. 1, 2A, 2B, 2C and 2D where FIGS. 2A, 2B, 2C and 2D illustrate the legacy fishing equipment represented in FIG. 1 equipped with a pair of underwater devices 100 in accordance with four different embodiments of the present invention.

Each underwater device 100 is adapted for being attached to the fishing equipment (i.e. the lower bridle 32, the warp 11 or the footrope 34) or to both the boat 10 and the fishing equipment. For example, as illustrated in FIG. 2A, the underwater devices 100 are shown as being attached along the lower bridles 32 of the fishing equipment. Alternatively, as illustrated in FIG. 2B, the underwater devices 100 are shown as being attached to the warps 11 of the fishing equipment. In still another alternative, the underwater devices 100 are illustrated in FIG. 2C as being attached to the fishing boat 10 by cables 12 for pulling the underwater device 100 and also attached by cables 13 to the fishing equipment for steering the section of the fishing equipment (e.g. the lower bridle 32 as illustrated in FIG. 2C) to which it is attached. In yet another alternative, the underwater devices 100 are illustrated in FIG. 2D as being attached along the footrope 34 of the fishing equipment.

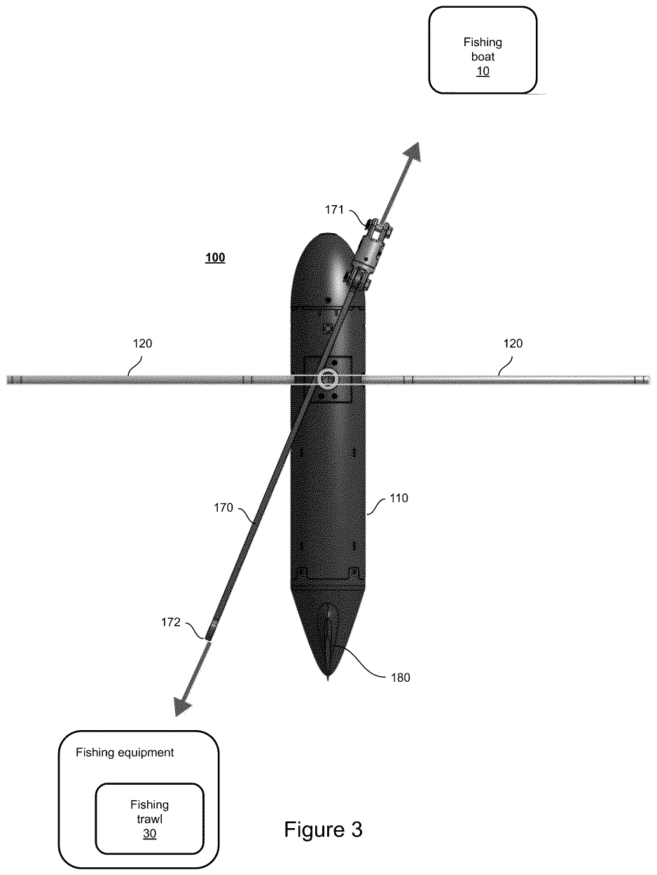

Reference is now further made to FIG. 3, which is a top view of the underwater device 100. The underwater device 100 comprises a central body 110 and a pair of adjustable hydrofoils 120, the hydrofoils 120 being positioned on each side of the central body 110. The shape and dimensions of the central body 110 may vary. The central body 110 represented in FIG. 3 has an elongated shape adapted for offering less resistance to water when being pulled in the water. Similarly, the shape and dimensions of the hydrofoils 120 may vary. For example, each hydrofoil 120 may have the shape of an aircraft wing. Alternatively, each hydrofoil 120 may have a flatter shape than an aircraft wing.

Each hydrofoil 120 of the underwater device 100 may be pivoted with respect to the central body 110 in clockwise or counterclockwise rotation, independently of one another. Thus the hydrofoils 120 may be pivoted in the same direction, in different directions, with the same angle of rotation, with different angles of rotation, etc. Furthermore, only one of the hydrofoils 120 may be rotated while the orientation of the other hydrofoil 120 is not modified (no rotation).

The underwater device 100 further comprises a rotating arm 170. In a first embodiment, a first extremity 171 of the rotating arm 170 is adapted for being attached to the fishing equipment as shown on FIGS. 2A, 2B and 2D. In another embodiment illustrated on FIG. 2C, the first extremity 171 of the rotating arm 170 is adapted for being attached to the fishing boat 10, and a second extremity of the rotating arm 170 further defines an opposite extremity 172 adapted for being attached to the fishing equipment. FIG. 3 illustrates the second embodiment. Any attachment mechanisms known in the commercial fishing industry or oceanic applications may be used for attaching the first extremity 171 of the rotating arm to the fishing equipment or the boat 10, and for attaching the second extremity 172 of the rotating arm to the fishing equipment. The central body 110 further comprises a fin 180. In an exemplary configuration illustrated in FIG. 3, the rotating arm 170 and the fin 180 are installed on opposite sides of the central body 110.

The fin 180 and the rotating arm 170 implement an orientation mechanism, which orients the central body 110 between the fishing boat 10 and the fishing trawl 30 (when the underwater device 100 is pulled underwater).

With respect to the rotating arm 170, the central body 110 self-aligns with the water flow via the rotating arm 170 (similarly to a weather vane). Alternatively, an arm controller may be used to control the orientation of the rotating arm 170.

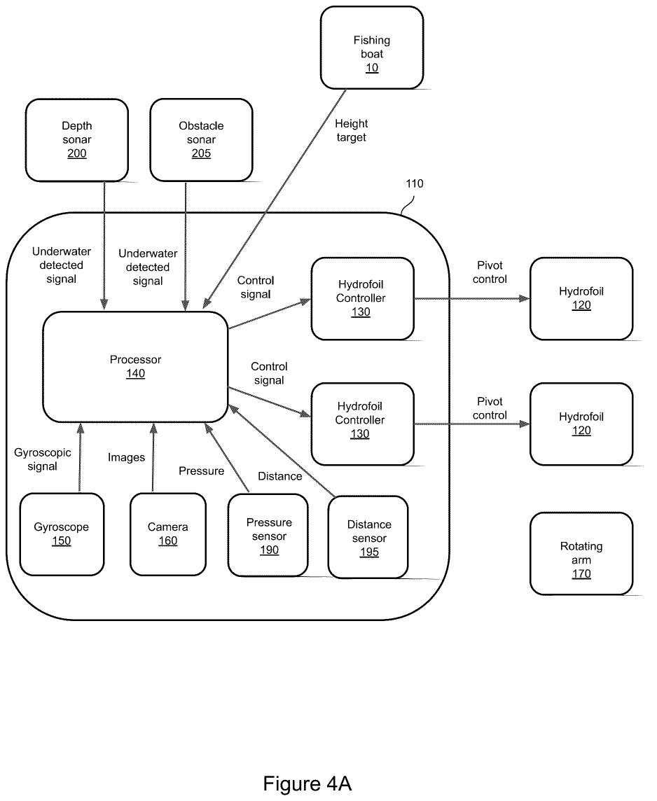

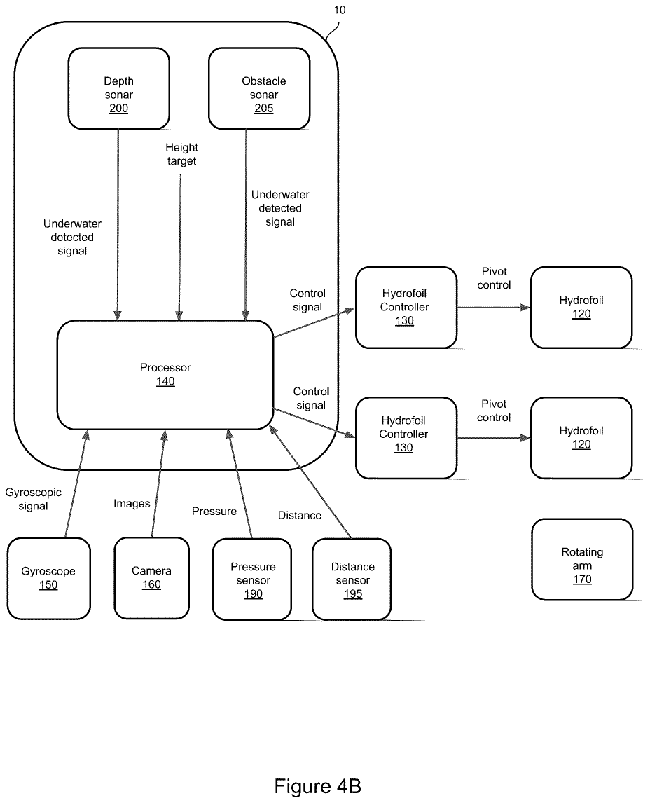

Reference is now made concurrently to FIGS. 2A, 2B, 2C, 2D, 3, 4A and 4B. FIG. 4A illustrates a schematic representation of components for controlling operation of the underwater device 100 in accordance with a first embodiment, where the components are inside or secured to the central body 110. FIG. 4B illustrates a schematic representation of components for controlling operation of the underwater device 100 in accordance with a second embodiment, where some of the components are onboard the boat 10 and other components are inside or secured to the central body 110. For simplicity purposes, components for only one underwater device 100 are illustrated.

The components for controlling each underwater device 100 include a processor 140, a pair of hydrofoil controllers 130, and a depth sonar 200. The components of the underwater device 100 further optionally include a gyroscope 150, a camera 160, an obstacle sonar 205, a pressure sensor 190, a distance sensor 195, a speed sensor (not represented in the Figures for simplification purposes), etc.

As mentioned previously, an arm controller (not represented in the Figures for simplification purposes) controlled by the processor 140 is optionally used to control the orientation of the rotating arm 170 (in an implementation where the central body 110 does not self-align with the water flow via the rotating arm 170).

In FIG. 4A, the depth sonar 200 is illustrated as being outside from the central body 110 (but in vicinity and secured to the central body 110, e.g. secured underneath the central body 110). In FIG. 4B, the depth sonar 200 is illustrated as being installed on the boat 10. Those skilled in the art will understand that other configurations for installing the depth sonar 200 are also within the scope of the present disclosure.

Sonars emit ultrasonic waves in the water, detects reflected echoes and generates therefrom an underwater detected signal. The depth sonar 200 is thus well known in underwater applications. The depth sonar 200 is used for detecting a depth of the water. The ultrasonic waves emitted by the depth sonar 200 are reflected by the sea floor in the form of the reflected echoes, from which the depth sonar 200 generates the underwater detected signal, which is representative of a vertical distance to the sea floor. The underwater detected signal is communicated to the processor 140. In use, each of the two underwater devices 100 could include a depth sonar 200, could communicate with a depth sonar 200 on the boat 10. Alternatively, one of the underwater device 100 could be equipped with a depth sonar 200 or communicate with a depth sonar 200 on the boat 10, and relay the underwater detected signal to the other underwater device 100 by any means appropriate for underwater communication such as for example acoustic signals or cables.

The processor 140 receives the underwater detected signal and controls the pair of hydrofoil controllers 130 based at least on the underwater detected signal. In an exemplary implementation, the processor 140 determines a first angle of rotation for one of the hydrofoils 120 (referred to a first hydrofoil for illustration purposes) and a second angle of rotation for the other hydrofoil 120 (referred to as the second hydrofoil for illustration purposes). The first and second angles of rotation may have the same value or different values. For example, if the processor 140 determines that the underwater device 100 is to move upward or downward, both hydrofoil controllers 130 will rotate at the same angle of rotation.

In a complementary embodiment, the processor 140 is further adapted to receive a height target from the fishing boat 10. The height target defines a target height (distance) relative to the sea floor (e.g. 50 meters above the sea floor). The processor 140 of both underwater devices 100 is responsible for steering the underwater fishing trawl 30, and enforcing the height target received from the boat 10. More specifically, the processor 140 processes the underwater detected signal received from the depth sonar 200 and the height target received from the boat 10, and controls the pair of hydrofoil controllers 130 based on the processing to enforce the height objective.

In another complementary embodiment, the central body 110 further comprises the pressure sensor 190 capable of estimating the current depth of the central body 110. For example, the pressure sensor 190 is used for validating that the height target received from the boat 10 has been reached.

In another complementary embodiment, the central body 110 further comprises the distance sensor 195 (e.g. a laser sensor, etc.) capable of determining (or at least estimating) a vertical distance to the sea floor. For example, the distance sensor 195 is used for validating, adjusting or replacing the measurements performed by the depth sonar 200.

Optionally, the hydrofoils 120 can also be controlled manually by an operator present on the boat 10. In the configuration illustrated in FIG. 4B, the operator interacts with the processor 140 located on the boat 10 (e.g. through a user interface). Control signals, generated based on the operator interactions, are transmitted by the processor 140 to the hydrofoil controllers 130. In the configuration illustrated in FIG. 4A, the operator interacts with a control device (not represented in the Figures) located on the boat 10. Operator commands, generated based on the operator interactions, are transmitted from the boat 10 to the processor 140 located in the central body 110. Control signals, generated based on the operator commands, are transmitted by the processor 140 to the hydrofoil controllers 130.

In still another complementary embodiment, the obstacle sonar 205 is used for detecting obstacles underwater (e.g. an object floating underwater) and/or for detecting shoals of fishes.

In FIG. 4A, the obstacle sonar 205 is illustrated as being outside from the central body 110 (but in vicinity and secured to the central body 110, e.g. secured in front of the central body 110). In FIG. 4B, the obstacle sonar 205 is illustrated as being installed on the boat 10. Those skilled in the art will understand that other configurations for installing the obstacle sonar 205 are also within the scope of the present disclosure.

In use, each of the two underwater devices 100 could include an obstacle sonar 205, could communicate with an obstacle sonar 205 on the boat 10. Alternatively, one of the underwater device 100 could be equipped with an obstacle sonar 205 or communicate with an obstacle sonar 205 on the boat 10, and relay the underwater detected signal to the other underwater device 100 by any means appropriate for underwater communication such as for example acoustic signals or cables.

Operations of the obstacle sonar 205 are similar to the previously described operations of the depth sonar 200. The ultrasonic waves emitted by the obstacle sonar 205 are reflected in the presence of an obstacle underwater or a shoal of fishes. The obstacle sonar 205 generates the underwater detected signal representative of the presence of the obstacle underwater or the shoal of fishes. The underwater detected signal is communicated to the processor 140, to be further processed. The processing results in the transmission, by the processor 140, of adequate control signals to the hydrofoil controllers 130 (e.g. actuation of the hydrofoils 120 so as to avoid the detected obstacle, actuating of the hydrofoils 120 so as to steer the fishing trawl 30 in the direction of the detected shoal of fishes, etc.). As will be detailed later in the description, an additional source of information (e.g. a camera) can be used to determine if the underwater detected signal is representative of the presence of an obstacle underwater or is representative of the presence of a shoal of fishes

For example, if the processor 140 determines that the underwater device 100 must remain at a current depth but move away from an obstacle or towards a shoal of fishes, the processor 140 instructs both hydrofoil controllers 130 to rotate in opposite directions so as to rotate the first and second hydrofoils 120 to change a direction of the central body 110 and thereby steer the fishing trawl 30 in a particular direction.

The processor 140 sends a first control signal (e.g. an electrical signal) representative of the first angle of rotation to the controller 130 (referred to as the first controller for illustration purposes) controlling the first hydrofoil 120. The processor 140 sends a second control signal (e.g. an electrical signal) representative of the second angle of rotation to the controller 130 (referred to as the second controller for illustration purposes) controlling the second hydrofoil 120.

Each controller 130 is adapted for controlling rotation of one of the hydrofoils 120 with respect to the central body 110. For example, upon reception of the first control signal, the first controller 130 activates an actuator which adjusts the rotation of the first hydrofoil 120 with respect to the central body 110, according to the first angle of rotation. Similarly, upon reception of the second control signal, the second controller 130 activates an actuator which adjusts the rotation of the second hydrofoil 120 with respect to the central body 110, according to the second angle of rotation.

More generally, by modifying the orientation of each hydrofoil 120 through rotation, the water flow on each side of the underwater device 100 moves the central body 110 in the water, which results in a vertical movement (upward or downward) of the underwater device 100, and roll variations. Consequently, the depth and orientation of the underwater device 100 is adjusted. The pair of underwater devices 100 being respectively directly or indirectly attached to one of the two extremities of the underwater fishing trawl 30, a coordinated adjustment of the depth and orientations of the underwater devices 100 results in a corresponding adjustment of the depth, spread and direction of the extremities of the underwater fishing trawl 30 (and also of the depth and orientations of the underwater fishing trawl 30).

The coordinated adjustment of the respective depths and orientation of the pair of underwater devices 100 results in a corresponding adjustment of the depth and direction of the fishing trawl 30, thereby preventing collision of the fishing trawl 30 with an obstacle detected by the obstacle sonar 205, or targeting capture of a shoal of fish also detected by the obstacle sonar 205.

The processor 140 may implement an algorithm to manage the potentially contradictory objectives of preventing collision of the fishing trawl 30 with an obstacle or targeting capture of a shoal of fish (based on the signals received from the obstacle sonar 205), and maintaining a pre-determined depth (based on the signals received from the depth sonar 200). For example, precedence could be temporarily given to obstacle avoidance or shoal of fish capture, upon depth stability.

The pair of underwater devices 100 is responsible for steering the underwater fishing trawl 30. As described previously, the steering is performed based on at least one of the following: remotely collected data (e.g. data transmitted by the fishing boat 10, such as the height objective, etc.) or locally collected data (e.g. data collected by at least some of the following components of the underwater devices 100: sonars 200 and 205, pressure sensor 190, gyroscope 150, camera(s) 160, speed sensor, etc.).

More specifically, the processor 140 determines respective angles of rotation (having the same or different values) for each one of the hydrofoils 120. The processor 140 sends a control signal to each controller 130, each control signal being representative of the angle of rotation of the hydrofoil 120 controlled by the controller 130. Upon reception of the control signal, each controller 130 adjusts the rotation of the hydrofoil 120 under its control with respect to the central body 110, according to the angle of rotation determined by the processor 140.

Adjusting the rotation of each hydrofoil 120 with respect to the central body 110 results in steering the underwater device 100 (depth and/or direction). The coordinated adjustment of the respective depths and directions of the pair of underwater devices 100 results in a corresponding adjustment of the depth and direction of the fishing trawl 30, thereby steering the fishing trawl 30.

The steering of the pair of underwater devices 100 (vertical control) may be complementary to the action of the pair of otter boards 20 (horizontal control).

In a complementary embodiment, the gyroscope 150 generates a gyroscopic signal. The processor 140 is further adapted for receiving the gyroscopic signal and controlling the pair of hydrofoil controllers 130 based on the gyroscopic signal for reducing rolling movement of at least one of the underwater device 100 and the fishing trawl 30.

In another complementary embodiment, the underwater device 100 further comprises one or more cameras 160 (a single camera 160 is represented in FIGS. 4A and 4B for illustration purposes only). The camera 160 can be at least partially integrated to the central body 110 (e.g. partially located inside the central body 110 to be protected from contact with water) or can be positioned on the central body 110.

Each camera 160 generates underwater images, transmitted to the processor 140. The processor 140 receives the underwater images, analyzes the underwater images and determines and/or confirms the presence of an obstacle or a shoal of fishes.

For example, the one or more cameras 160 are used in conjunction with the obstacle sonar 205. In some instances, the obstacle sonar 205 may not be capable of detecting the difference between a large mammal and a real obstacle, which both result in the generation by the obstacle sonar 205 of an underwater detected signal. Thus, upon reception of the underwater detected signal by the processor 140, the analysis of the underwater images is performed by the processor 140, to confirm the presence of a real obstacle (which should be avoided by the fishing trawl 30) or the presence of a large mammal (which should be targeted by the fishing trawl 30).

Since the processing of images is very demanding in terms of processing resources of the processor 140, analyzing the images only when an underwater detected signal is received by the processor 140 saves processing resources.

The processing of the images by the processor 140 is performed by an algorithm capable of analyzing the images and identifying the presence of an obstacle, large mammal or a shoal of fishes. In an exemplary implementation, the algorithm is a machine learning algorithm, for example an algorithm implementing a neural network. The usage of the machine learning algorithm provides additional functionalities, such as recognizing different types of fish, which can be used to follow regulations relative to the type and/or quantity of fish which can be caught.

In still another complementary embodiment, the processor 140 of each underwater device 100 is further adapted to implement the functionality of closing and opening the underwater fishing trawl 30 while being pulled.

Although not represented in FIGS. 4A and 4B for simplification purposes, the underwater device 100 also comprises a communication unit, for communicating with the fishing boat 10 and/or the other underwater device 100 via one of the aforementioned cable or acoustic communication device.

Although the fishing equipment represented in FIGS. 2A-2D comprises a pair of underwater devices 100, additional underwater device(s) 100 may be used to implement the previously described functionalities.

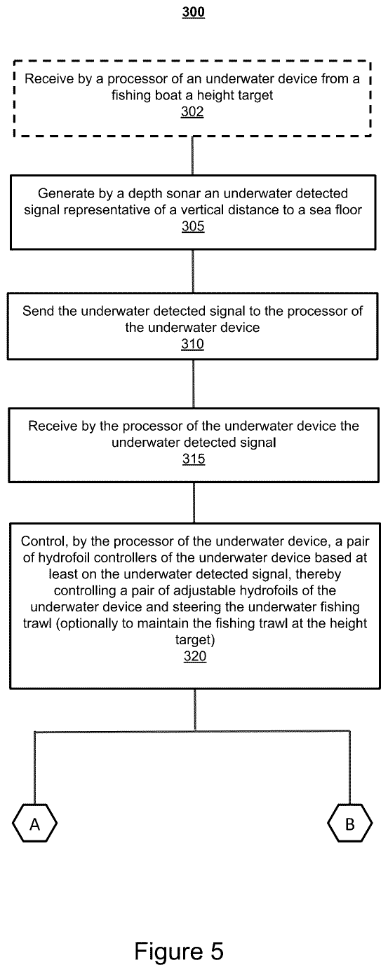

Reference is now made concurrently to FIGS. 2A, 2B, 2C, 2D, 3, 4A and 5, where FIG. 5 illustrates a method 300 for steering the underwater fishing trawl 30 while being pulled by the fishing boat 10. Details about the implementations of each step are not provided, since these details have been provided previously. Furthermore, the various embodiments and implementation/configuration options described previously are applicable to the method 300.

The method 300 comprises the optional step 302 of receiving by the processor 140 of one of the underwater devices 100 from the fishing boat 10 a height objective. The height target is generally sent to each underwater device 100, but may also be sent to only one of them. The present method 300 focuses on the operations of one of the underwater devices 100. The other underwater device 100 implements the same method 300. If step 302 occurs, then step 320 takes into consideration the height objective.

The method 300 comprises the step 305 of generating by the depth sonar 200 an underwater detected signal representative of a vertical distance to a sea floor.

The method 300 comprises the step 310 of sending the underwater detected signal to the processor 140 of the underwater device 100. As mentioned previously, each underwater device 100 has its own dedicated depth sonar 200 or a single depth sonar 200 is used by all the underwater devices 100.

The method 300 comprises the step 315 of receiving, by the processor 140 of the underwater device 100, the underwater detected signal.

The method 300 comprises the step 320 of controlling, by the processor 140 of the underwater device 100, the pair of hydrofoil controllers 130 of the underwater device 100 based at least on the underwater detected signal, thereby controlling the pair of adjustable hydrofoils 120 of the underwater device 100 and steering the underwater fishing trawl 30.

If step 302 has occurred and the height target has been received by the processor 140, then step 320 takes into consideration the height target as follows: the processor 140 controls the pair of hydrofoil controllers 130 based at least on the underwater detected signal to maintain the fishing trawl 30 at the height objective.

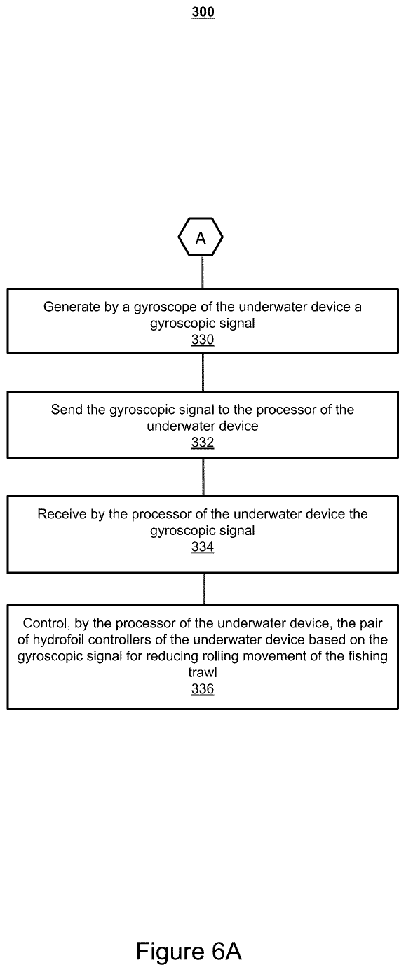

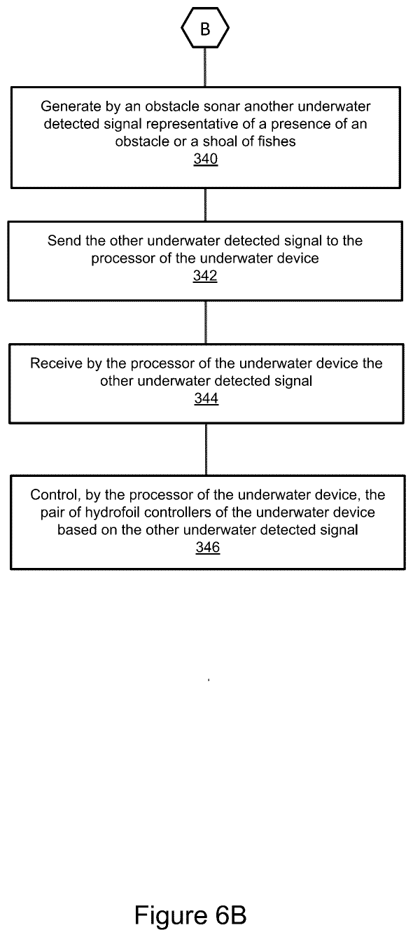

Additional steps may be performed before or after performing steps 305-320, or concurrently to performing steps 305-3200. Examples of these additional steps will be described in relation to FIGS. 6A-B. Furthermore, steps 305-320 are repeated sequentially over time.

One or more dedicated computer programs have instructions for implementing some of the steps of the method 300. The instructions are comprised in a non-transitory computer-readable medium (e.g. a memory not represented in FIG. 4A for simplification purposes) of the central body 110 of each underwater device 100. The instructions, when executed by the processor 140, provide for steering the underwater fishing trawl 30 being pulled by the fishing boat 10 (by implementing some of the steps of the method 300). More specifically, the instructions executed by the processor 140 implement steps 302, 315 and 320.

Reference is now made concurrently to FIGS. 2A, 2B, 2C, 2D, 3, 4A, 5 and 6A, where FIG. 6A illustrates additional steps of the method 300.

The method 300 comprises the step 330 of generating by the gyroscope 150 of the underwater device 100 the gyroscopic signal.

The method 300 comprises the step 332 of transmitting the gyroscopic signal to the processor 140 of the underwater device 100.

The method 300 comprises the step 334 of receiving, by the processor 140 of the underwater device 100, the gyroscopic signal.

The method 300 comprises the step 336 of controlling, by the processor 140 of the underwater device 100, the pair of hydrofoil controllers 130 of the underwater device 100 based on the gyroscopic signal for reducing rolling movement of the fishing trawl 30.

Although represented after steps 305-320 for illustration purposes in FIG. 6A, steps 330-334 can be performed before, during or after steps 305-320. For example, steps 320 and 336 are merged to take into account simultaneously the underwater detected signal, the gyroscopic signal and optionally the height target for controlling the pair of hydrofoil controllers 130 by the processor 140.

The instructions comprised in the aforementioned non-transitory computer-readable medium, when executed by the processor 140, further implement steps 334 and 336.

Reference is now made concurrently to FIGS. 2A, 2B, 2C, 2D, 3, 4A, 5 and 6B, where FIG. 6B illustrates additional steps of the method 300.

The method 300 comprises the step 340 of generating by the obstacle sonar 205 another underwater detected signal representative of a presence of an obstacle or a shoal of fishes.

The method 300 comprises the step 342 of sending the other underwater detected signal to the processor 140 of the underwater device 100. As mentioned previously, each underwater device 100 has its own dedicated obstacle sonar 205 or a single obstacle sonar 205 is used by all the underwater devices 100.

The method 300 comprises the step 344 of receiving, by the processor 140 of the underwater device 100, the other underwater detected signal.

The method 300 comprises the step 346 of controlling, by the processor 140 of the underwater device 100, the pair of hydrofoil controllers 130 of the underwater device 100 based on the other underwater detected signal.

As mentioned previously, controlling the pair of hydrofoil controllers 130 based on the other underwater detected signal thereby controls the pair of adjustable hydrofoils 120 to avoid the obstacle or to steer the fishing trawl 30 in the direction of the shoal of fishes.

Although represented after steps 305-320 for illustration purposes in FIG. 6B, steps 340-344 can be performed before, during or after steps 305-320. As mentioned previously, the processor 140 may implement an algorithm to manage the potentially contradictory objectives steps 320 and 346. For example, precedence could be temporarily given to obstacle avoidance or shoal of fish capture (step 346), over height target achievement (step 320).

The instructions comprised in the aforementioned non-transitory computer-readable medium, when executed by the processor 140, further implement steps 344 and 346.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A system for steering an underwater fishing trawl, the system comprising:
a depth sonar generating an underwater detected signal representative of a vertical distance to a sea floor;
a pair of underwater devices, each underwater device being adapted for being pulled by a fishing boat and for steering one of two extremities of the underwater fishing trawl, each underwater device comprising:
a central body;
a pair of adjustable hydrofoils, the hydrofoils being positioned on each side of the central body;
a pair of controllers, each controller being adapted for controlling rotation of one of the hydrofoils with respect to the central body; and
a processor for receiving the underwater detected signal and for controlling the pair of controllers based at least on the underwater detected signal, thereby controlling the pair of adjustable hydrofoils and steering the underwater fishing trawl.

2. The system of claim 1, wherein the depth sonar is positioned on one of the underwater devices.

3. The system of claim 1, wherein the underwater devices further comprise an orientation mechanism for orienting the central body between the fishing boat and the fishing trawl.

4. The system of claim 3, wherein the orientation mechanism comprises a rotating arm and a fin installed on the central body.

5. The system of claim 4, wherein one extremity of the rotating arm is pulled by the fishing boat and another extremity of the rotating arm is attached to a fishing equipment comprising the fishing trawl.

6. The system of claim 1, wherein the processor of each underwater device is further adapted for receiving from the fishing boat a height target and controlling the pair of controllers to maintain the fishing trawl at the height objective, the height target defining a target height relative to the sea floor.

7. The system of claim 1, wherein:
each underwater device further comprises a gyroscope for generating a gyroscopic signal; and
the processor of each of the underwater devices is further adapted for receiving the gyroscopic signal and controlling the pair of controllers based on the gyroscopic signal for reducing rolling movement of the fishing trawl.

8. The system of claim 1, further comprising another sonar generating another underwater detected signal representative of a presence of an obstacle or a shoal of fishes, and wherein the processor is further adapted for receiving the other underwater detected signal and controlling the pair of controllers based on the other underwater detected signal.

9. The system of claim 8, further comprising at least one camera, the camera generating underwater images, and wherein the processor is further adapted for analyzing the underwater images and confirming presence of an obstacle or a shoal of fishes.

10. The system of claim 8, wherein controlling the pair of controllers based on the other underwater detected signal thereby controls the pair of adjustable hydrofoils to avoid the obstacle or to steer the fishing trawl in the direction of the shoal of fishes.

11. The system of claim 1, wherein the pair of underwater devices are further adapted for closing and opening the underwater fishing trawl while being pulled.

12. The system of claim 1, further comprising an additional distance sensor adapted for determining a vertical distance to the sea floor.

13. An underwater device adapted for being attached to an underwater fishing trawl system, the underwater fishing trawl system comprising a fishing trawl and a fishing boat, the underwater device comprising:
a central body;
a pair of adjustable hydrofoils, the hydrofoils being positioned on each side of the central body;
a pair of controllers, each controller being adapted for controlling rotation of one of the hydrofoils; and
a processor for receiving a sonar signal representative of a vertical distance to a sea floor and for controlling the pair of controllers based at least on the sonar signal, thereby controlling the pair of adjustable hydrofoils and steering the underwater fishing trawl.

14. The underwater device of claim 13, further comprising a sonar for generating the sonar signal.

15. The underwater device of claim 13, further comprising an orientation mechanism for orienting the central body between the fishing boat and the fishing trawl.

16. The underwater device of claim 15, wherein the orientation mechanism comprises a rotating arm and a fin installed on the central body.

17. The underwater device of claim 16, wherein one extremity of the rotating arm is pulled by the fishing boat and another extremity of the rotating arm is attached to a fishing equipment comprising the fishing trawl.

18. The underwater device of claim 13, wherein the processor is further adapted for receiving from the fishing boat a height target and controlling the pair of controllers to maintain the fishing trawl at the height target, the height target defining a target height relative to the sea floor.

19. The underwater device of claim 13, further comprising a gyroscope for generating a gyroscopic signal; and
the processor is further adapted for receiving the gyroscopic signal and controlling the pair of controllers based on the gyroscopic signal for reducing rolling movement of at least one of the underwater device and the fishing trawl.

20. The underwater device of claim 13, wherein the processor is further adapted for receiving another sonar signal representative of a presence of an obstacle or a shoal of fishes, and controlling the pair of controllers based on the other sonar signal.

21. The underwater device of claim 20, further comprising at least one camera, the camera generating underwater images, and wherein the processor is further adapted for analyzing the underwater images and confirming presence of an obstacle or of a shoal of fishes.

22. The underwater device of claim 20, wherein controlling the pair of controllers based on the other sonar signal thereby controls the pair of adjustable hydrofoils to avoid the obstacle or to steer the fishing trawl in the direction of the shoal of fishes.

23. The underwater device of claim 13, being further adapted for closing and opening the underwater fishing trawl while being pulled.
